(19) United States
(12) Patent Application Publication
(10) Pub. No.: US 2022/0398255 A1
(43) Pub. Date: Dec. 15, 2022

(54) INTELLIGENT APPLICATION CLUSTERING FOR SCALABLE GRAPH VISUALIZATION USING MACHINE LEARNING

(71) Applicant: VMware, Inc., Palo Alto, CA (US)

(72) Inventors: Anthony Fenzl, Sunnyvale, CA (US); Vinith Podduturi, Fremont, CA (US); Kamalika Das, Sunnyvale, CA (US); Karen Hayrapetyan, Fremont, CA (US); Margaret Petrus, San Jose, CA (US)

(21) Appl. No.: 17/837,334

(22) Filed: Jun. 10, 2022

Related U.S. Application Data
(60) Provisional application No. 63/209,402, filed on Jun. 11, 2021.

(51) Int. Cl. G06F 16/26; G06F 16/28; H04L 9/40

(52) U.S. Cl. CPC G06F 16/26; G06F 16/285; H04L 63/20

(57) ABSTRACT

Some embodiments provide a mechanism to automatically group workloads of a network into clusters of related workloads. The method of some embodiments displays consolidated workload data for a network. The method, for each of multiple workloads: (1) receives a set of identifiers characterizing the workload; and (2) converts the set of identifiers to a vector representation of the workload. The method then identifies clusters of workloads based on the vector representations of the workloads. The method then displays the workloads grouped in the identified clusters and displays data flows between the clusters of workloads. Converting the set of identifiers to a vector representation of the workload may include applying a similarity metric to the set of identifiers.

Distributed analytics engines are network visualization tools for displaying security and policy data for workloads and the connections between them in network datacenters. Such engines create large scale graphs in a user interface (UI) for visualizing the network and security posture of private and/or public datacenter networks (e.g., logical and/or physical networks). A network admin or security admin can leverage these engines to gain powerful insight into the workloads of a logical and/or physical network operating in one or more datacenters, allowing them to better protect the logical network. However, when a particular network instantiates many workloads (e.g., utilizing tens of thousands of VMs, bare-metal servers, and other types of compute resources), visualizing even a subset of these vertices (workloads that communicate with other workloads) and their flows can be quite confusing to the admins. The previous art does not provide a good way of visualizing the graphs of the UI, in a way that is scalable to tens of thousands of workloads, without significant or even overwhelming manual work for the admins.

In the existing art, admins can define their own groups of workloads and apply filters in order to enable more effective visualization. However, if the admin wants to view interactions between many individual computes, or if the admin has not defined a robust set of groups, then visualization at scale becomes an incomprehensible jumble of unrelated workloads and their connections rather than a useful visual reference. Therefore, there is a need in the art for a machine learning technique to automatically define groups of workloads into related clusters.

### BRIEF SUMMARY

Some embodiments provide a mechanism to automatically group workloads of a logical and/or physical network into clusters of related workloads. The method of some embodiments displays consolidated workload data for a logical and/or physical network. The method, for each of multiple workloads: (1) receives a set of identifiers characterizing the workload; and (2) converts the set of identifiers to a vector representation of the workload. The method then identifies clusters of workloads based on the vector representations of the workloads. The method then displays the workloads grouped in the identified clusters and displays data flows between the clusters of workloads. Converting the set of identifiers to a vector representation of the workload may include applying a similarity metric to the set of identifiers.

The identifiers characterizing the workload may include a compute name of the workload and/or a set of identifying metadata (e.g., tags, labels, comments, annotations and/or other user provided descriptive values, etc.) of the workload. The similarity metrics used in some embodiments may include Jaro similarity metrics and/or Jaccard similarity metrics. Displaying data flows between the clusters of workloads includes, displaying data flows between a first workflow in a first cluster and a second workflow in a second cluster in some embodiments.

The method of some embodiments, identifies clusters of workloads, based on the vector representations of the workloads, by creating a matrix of the vector representations of the workloads in the workloads. Identifying clusters of workloads based on the vector representations of the workloads may also include reducing a dimensionality of the vectors in the matrix using principal component analysis (PCA). Identifying clusters of workloads based on the vector representations of the workloads may also include applying a clustering algorithm to the matrix. The clustering algorithm, in some embodiments, is a hierarchical density based spatial clustering of applications with noise (HDBSCAN) algorithm.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF THE DRAWINGS

The novel features of the invention are set forth in the appended claims. However, for purposes of explanation, several embodiments of the invention are set forth in the following figures.

FIG. 1 illustrates a security display interface of some embodiments for identifying workloads of a logical and/or physical network and their connections.

FIG. 2 illustrates modules of an automatic clustering application.

FIG. 3 conceptually illustrates a general process of some embodiments for automatically grouping workloads of a logical and/or physical network for display in a GUI.

FIG. 4 conceptually illustrates a process of some embodiments for converting workload names into vectors for later clustering analysis.

FIG. 5 conceptually illustrates a process of some embodiments for converting workload identifying metadata into vectors for later clustering analysis.

FIG. 6 conceptually illustrates a process of some embodiments for generating a similarity score for each workload based on both the workload name and identifying metadata.

FIG. 7 conceptually illustrates a process of some embodiments for identifying clusters of workloads.

FIG. 8 illustrates an example of a datacenter in which some embodiments of the invention are implemented.

FIG. 9 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a mechanism to automatically group workloads of a logical and/or physical network into clusters of related workloads. The method of some embodiments displays consolidated workload data for a logical and/or physical network. The method, for each of multiple workloads: (1) receives a set of identifiers characterizing the workload; and (2) converts the set of identifiers to a vector representation of the workload. The method then identifies clusters of workloads based on the vector representations of the workloads. The method then displays the workloads grouped in the identified clusters and displays data flows between the clusters of workloads. Converting the set of identifiers to a vector representation of the workload may include applying a similarity metric to the set of identifiers.

The identifiers characterizing the workload may include a compute name of the workload and/or a set of identifying metadata of the workload. The similarity metrics used in some embodiments may include Jaro similarity metrics and/or Jaccard similarity metrics. Displaying data flows between the clusters of workloads includes displaying data flows between a first workflow in a first cluster and a second workflow in a second cluster in some embodiments.

The method of some embodiments identifies clusters of workloads, based on the vector representations of the workloads, by creating a matrix of the vector representations of the workloads in the workloads. Identifying clusters of workloads based on the vector representations of the workloads may also include reducing a dimensionality of the vectors in the matrix using principal component analysis (PCA). Identifying clusters of workloads based on the vector representations of the workloads may also include applying a clustering algorithm to the matrix. The clustering algorithm, in some embodiments, is a hierarchical density based spatial clustering of applications with noise (HDBSCAN) algorithm.

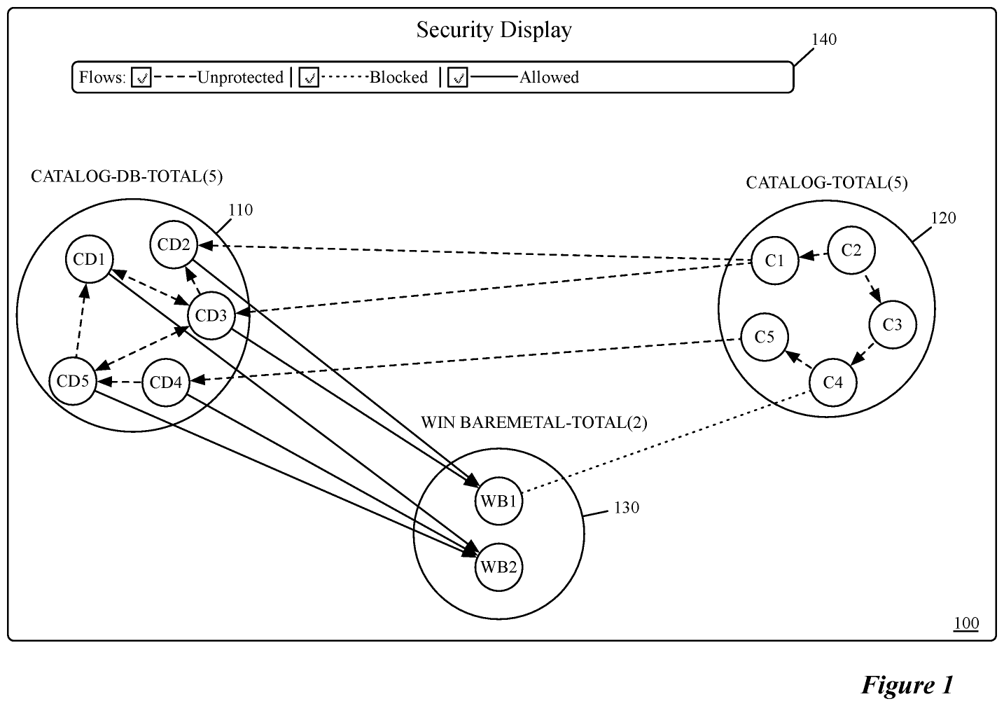

FIG. 1 illustrates a security display interface 100 of some embodiments for identifying workloads of a logical and/or physical network and their connections. FIG. 1 includes the security display interface 100, clusters 110, 120, and 130 and legend 140. Cluster 110 includes all workloads with workload names including “catalog-DB” (e.g., catalog-DB-1, catalog-DB-2, etc.). Some embodiments automatically generate abbreviated names to identify workloads in order to save display space without reducing font sizes below easy readability. For example, workload “catalog-DB-1” is represented in FIG. 1 as CD1; workload “catalog-1” is represented as C1, etc., due to limited display space. Cluster 120 includes all workloads with workload names including “catalog” but not including “DB” (e.g., catalog-1, catalog-2, etc.). Cluster 130 includes all workloads with workload names including “Win Baremetal” (i.e., Win Baremetal-1 and Win Baremetal-2).

The connections between the workloads within clusters and between clusters are displayed according to the line patterns shown in the legend 140. Legend 140 includes patterns for unprotected connections, such as the connections between workloads within clusters 110 and 120, allowed connections, such as the connections between workloads of cluster 110 and cluster 130, and blocked connections, such as the connection between workload Win Baremetal-1 and Catalog-4. In the embodiment of FIG. 1, the Security display interface 100 includes check boxes in the legend 140 to allow a user to display or hide different connection types by checking or unchecking the check boxes.

In some embodiments, the Security display interface 100 provides options to modify characteristics of workloads, resources available to workloads, number of simultaneous instances of particular types of workload, etc. Such options may be provided in some embodiments by a menu (e.g., a pop-up menu) activated by operation of a user interface device in relation to the workloads (e.g., a mouse button click/double-click, a touch screen selection, etc.). However, in other embodiments, other controls for such modifications are provided. Similarly, the Security display interface 100 of some embodiments includes options to modify the characteristics of connections between workloads. As with the workload modification options, these may be provided by a menu accessed with a selection by a user interface device or by some other controls. For example, in some embodiments, the Security display interface 100 of some embodiments includes an option to change the status of a displayed set of connections from blocked to unblocked or vice versa, with the interface creating or modifying underlying rules (e.g., firewall rules) to implement the change in status. Similarly, in some embodiments the number of connections between clusters can be limited to a maximum or minimum number of separate connections, limited to a maximum or minimum bandwidth, allocated reserved bandwidth, have additional or reduced security features applied, etc.

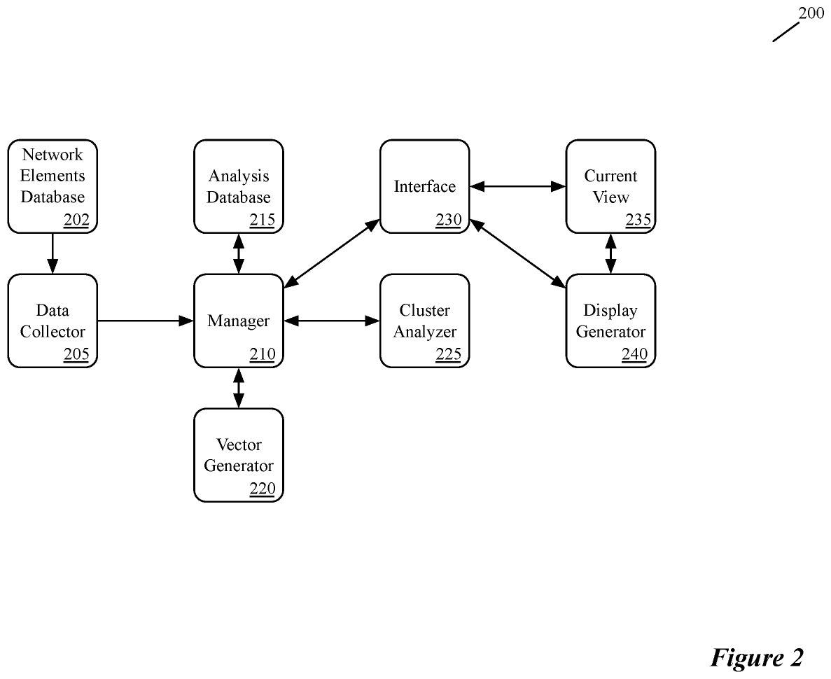

FIG. 2 illustrates modules of an automatic clustering application 200. The application 200 includes modules 205-240 that collectively generate a display such as the security display 100 of FIG. 1. In FIG. 2, data collector 205 receives data from the network elements database 202. This data may include names, workload identifiers, workload identifying metadata, or other information. In some embodiments, the network elements database 202 is a database of a logical and/or physical network created by the network for purposes other than or in addition to workload cluster analysis but accessed by the automatic clustering application 200. In other embodiments, the network elements database 202 is implemented as part of the automatic clustering application to store workload identification data received from the network.

The set of workloads of a network are generally not static, but may have new workloads added or old workloads deleted or modified (e.g., a workload may be renamed or the workload identifying metadata may change). Therefore, the data collector 205 receives new workload data as the workload data changes. The data collector 205 sends the workload data to a manager 210.

In the illustrated embodiment, the manager 210 acts as a central control and middle box for data being passed to various modules 215-225 that store and analyze the workload data and also to the interface module 230 for the workload display. However, one of ordinary skill in the art will understand that in some embodiments, modules 215-225 pass data directly between them. The manager 210 sends the workload data (workload IDs, names, identifying metadata, etc.) to the analysis database 215. Additionally, in some embodiments, the analysis database 215 stores derived data generated by other modules (e.g., the vectors, generated from vector generator 220, which are analyzed to generate the clusters, and the clusters themselves produced by the cluster analyzer 225).

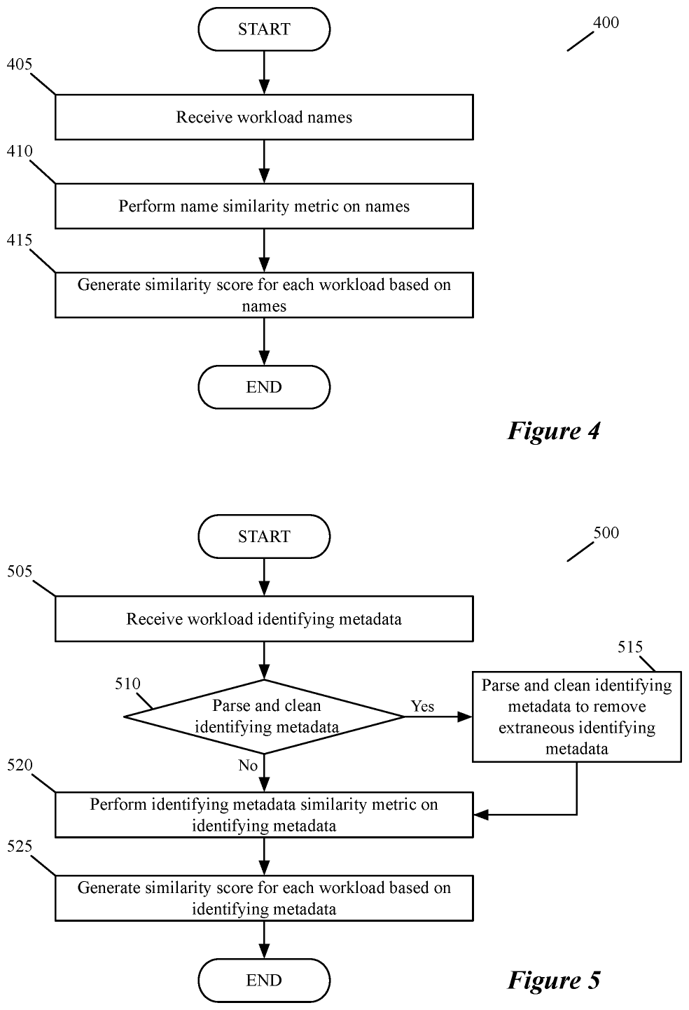

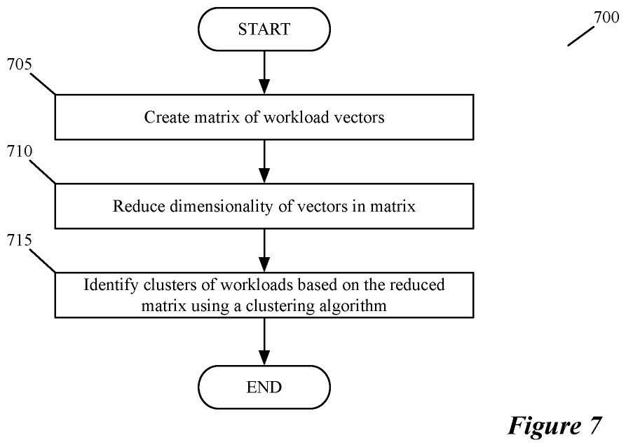

The manager 210 sends the workload data to a vector generator module 220, which converts the workload data into vectors and calculates a similarity score for each vector (See, e.g., FIGS. 4 and 5). In some embodiments, the manager 210, of FIG. 2, stores the vectors and similarity scores in the analysis database 215. The manager 210 then sends the similarity scores to the cluster analyzer 225. Although the cluster analyzer 225 in the illustrated embodiment receives the similarity scores from the manager, in some embodiments, the cluster analyzer 225 receives the similarity scores directly from the vector generator module 220. The cluster analyzer 225 determines which workloads should be clustered together, for display purposes, based on the similarity scores (See, e.g., FIG. 7) and provides the cluster data to the manager 210 of FIG. 2 (which stores the cluster analysis data in the analysis database 215).

The analysis database 215 thus has the data necessary to generate a display. An administrator activates the interface module 230 (e.g., through a GUI that can access the workload clustering application) to call up the display. The interface module 230 retrieves the workload and cluster data from the manager 210 (or in some embodiments, directly from the analysis database 215). The interface module sends the workload and cluster data to a current view module 235, which provides the current view to a display generator 240. The administrator is then able to adjust the view by interacting with a GUI that activates the interface module 230. For example, as shown in FIG. 1, the GUI may include options to display or hide particular types of connections. Additionally, the GUI, in some embodiments, allows additional functions, such as zooming and viewing, and modifying workload names, identifying metadata, or other data, etc., in on particular clusters. Furthermore, in some embodiments, the GUI includes options to modify characteristics of workloads, resources available to workloads, number of simultaneous instances of particular types of workload, etc. Similarly, the GUI of some embodiment includes options to modify the characteristics of connections between workloads. For example, in some embodiments, the GUI of some embodiments includes an option to change the status of a displayed set of connections from blocked to unblocked or vice versa, with the interface creating or modifying underlying rules (e.g., firewall rules) to implement the change in status.

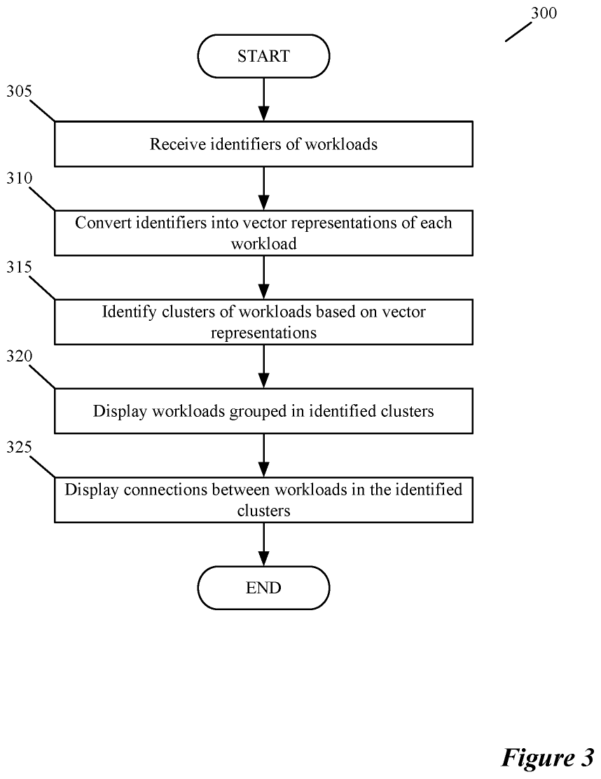

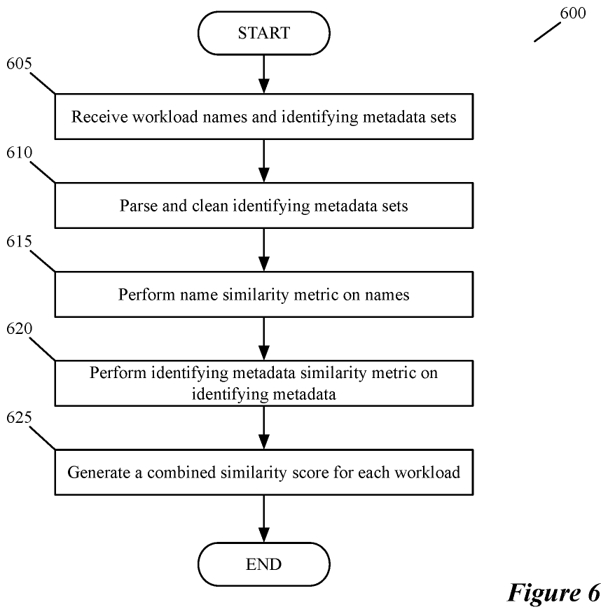

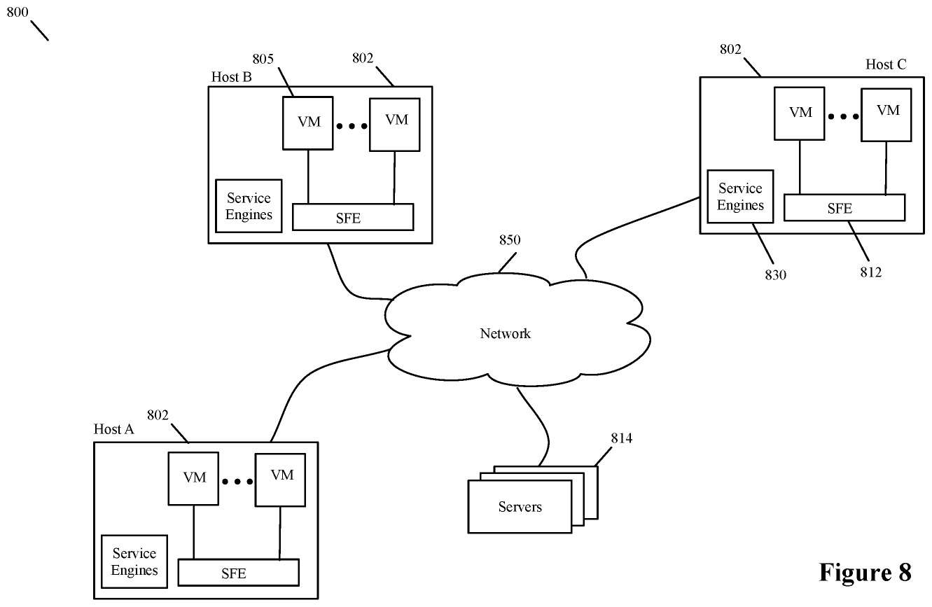

FIGS. 3-7 conceptually illustrate processes of some embodiments for generating a GUI that shows workloads and their connections. FIG. 3 conceptually illustrates a general process 300, of some embodiments, for automatically grouping workloads of a network for display in a GUI. FIGS. 4-7 conceptually illustrate more details of sub-processes that together, make up process 300 of FIG. 3. The process 300 begins when it receives (at 305) identifiers of workloads of the network. The workloads may be implemented in some embodiments, on any or all of: (1) virtual machines of the logical network, (2) hosts of a network, (3) servers of a network, (4) containers of a container network (e.g., a Kubernetes network) implemented on the logical and/or physical network, etc. A network of some embodiments is illustrated in FIG. 8. Some embodiments use the names of the workloads as identifiers (See, e.g., FIG. 4), some embodiments use identifying metadata of the workloads as identifiers (See, e.g., FIG. 5), and some embodiments use both names and identifying metadata of the workloads as identifiers (See, e.g., FIG. 6).

The process 300 of FIG. 3 then converts (at 310) the received identifiers into vector representations of each workload. The process 300 identifies (at 315) clusters of workloads based on the vector representations of the identifiers. The process 300 displays (at 320) representations of the workloads grouped in their identified clusters and displays (at 325) the connections between the workloads in a GUI, such as the security display interface 100 of FIG. 1. The process 300 then ends.

In the present practice of operating networks, the administrators who set up the workloads of the networks typically provide meaningful names for the workloads. For example, workloads handling the database of a catalog of goods and/or services might all be named “Catalog-DB-n”, where n is a number or other designation identifying a specific catalog database handling workload. Giving the workloads obviously meaningful names simplifies processes of troubleshooting and analysis of the network, which is why it is a common practice. However, even in cases where the names of workloads are not obviously meaningful, network administrators usually apply some non-arbitrary naming convention to the workload names (e.g., all catalog databases workload names might start with the same arbitrary combination of symbols that are distinct from other types of workload).

For networks where the workload names are not arbitrary, some embodiments of the present invention, group workloads into cluster by workload names. In some embodiment, a user is presented with an option of whether to group workloads into clusters based on workload names, in other embodiments, the processes of the invention automatically determine whether workload names are non-arbitrary. FIG. 4 conceptually illustrates a process 400 of some embodiments for converting workload names into vectors for later clustering analysis. The process 400, in some embodiments, is a more detailed sub-process of one implementation of operations 305 and 310 of process 300 of FIG. 3. The process 400 receives (at 405) the names of workloads of the network. The process 400 performs (at 410) a name similarity metric on the names. In some embodiment, the name similarity metric is a Jaro string similarity metric. In some embodiments, the Jaro string similarity metric and/or some other similarity metric is applied to every workload name in order to compare the similarity of each workload name to each other workload name. Some embodiments use the following formula for each possible pair of workload names (e.g., comparing each workload name to the names of every other workload) to compute a name similarity value.

$${s}_{n} = \{ \begin{matrix} \\ \frac{1}{3} ( \frac{m}{\vert {n}_{0} \vert} + \frac{\begin{matrix}0 , \\ m\end{matrix}}{\vert {n}_{1} \vert} + \frac{m - t}{m} )\end{matrix} , \begin{matrix}if m = 0 \\ otherwise\end{matrix} \qquad ( eq . 1 )$$

### Where:

m: number of matching characters between n₀ and n₁
|n₀| and |n₁|: length of compute names
t: half the number of transpositions
example: n₀=hello, n₁=yellow

$${s}_{n} = \frac{1}{3} ( \frac{4}{5} + \frac{4}{6} + \frac{4 - 0}{4} ) = 0.8 \overline{2} \qquad ( eq . 2 )$$

However, other embodiments calculate name similarity values using other formulas.

The process 400 then generates (at 415) a similarity score for each workload based on the workload names. In some embodiments, generating the similarity score for a particular workload may include storing the calculated similarity scores for each name similarity calculation between the particular workload and each of the other workloads (e.g., as a vector associated with the particular workload). In other embodiments, generating the similarity score for each workload further includes some further mathematical, data aggregation, or data organizing of the name similarity metric data produced in operation 410. After generating the similarity scores for each workload, the process 400 then ends.

In some network settings, instead of or in addition to implementing meaningful/non-arbitrary names for workloads, the administrators supply identifying metadata (e.g., tags, labels, comments, annotations and/or other user provided descriptive values etc.) for each of multiple workloads. For example, a set of identifying metadata could include one item of identifying metadata that identifies a workload as applying to a DB, another item of identifying metadata that identifies it as applying to the products database, another item of identifying metadata identifying what application the workload is implementing, another item of identifying metadata that identifies what type of connections the workload needs, etc.

FIG. 5 conceptually illustrates a process 500 of some embodiments for converting workload identifying metadata into vectors for later clustering analysis. The process 500, in some embodiments, is a more detailed sub-process of one implementation of operations 305 and 310 of process 300 of FIG. 3. The process 500 receives (at 505) sets of workload identifying metadata for workloads of the network. The process 500 determines (at 510) whether to parse and clean the identifying metadata of the workload sets. For example, there may be some identifying metadata items that are unique to a particular workload or apply to a very small number of workloads so that they are not useful in identifying clusters of related workloads.

If the process 500 determines (at 510) the identifying metadata should be parsed and cleaned, then the process 500 parses and cleans (at 515) the identifying metadata to remove extraneous metadata items and/or extraneous parts of identifying metadata items. For example, to parse the identifying metadata items, the process 500 may identify distinct words appearing in an identifying metadata item, such as by identifying the words “database,” “merchandise,” and “food” in an identifying metadata item that includes a single string “database_merchandise_food”. Such parsing, in some embodiments, results in grouping into a cluster of workloads where not all workloads have the same exact identifying metadata item.

Operation 515 also cleans the identifying metadata of extraneous items (items that are less helpful or unhelpful in identifying useful clusters). Some embodiments have a minimum cluster size for the number of workloads in each cluster. The minimum cluster size may be set by a user or derived automatically by the automated clustering method. In such embodiments, identifying metadata items appearing in fewer workloads than the minimum cluster size may be cleaned from the identifying metadata of the workloads. For example, if the minimum cluster size is five workloads, and only two workloads are associated with a particular identifying metadata item, then that identifying metadata item might be cleaned from the metadata items to be used for determining how to cluster the workloads.

Even when a particular identifying metadata item is common, it may be removed in the cleaning operation as not being relevant enough to identifying related workload groups. For example, some workloads may be associated with an identifying metadata item that identifies the date or time that the workload was implemented. Several otherwise unrelated workloads might happen to have the same date or time. In such a case, an identifying metadata item specifying a particular date may be (1) more common than the number of workloads in the minimum cluster size, but (2) not helpful in separating the workloads into relevant groups. Therefore, in some embodiments, identifying metadata items specifying dates or times or similarly low or no relevance data are removed. Finally, an identifying metadata item may include both relevant and less relevant information (e.g., “database_merchandise_food_06_06_2021” that includes both a description of the workload and a date). The parsing and cleansing of the identifying metadata item, in some embodiments, may remove the less relevant information (here, the date) and leave the relevant information “database_merchandise_food” to be evaluated in later operations of process 500.

One of ordinary skill in the art will understand that in some embodiments, these identifying metadata items are not removed from association with the workloads themselves, only from the set of received identifiers used to identify clusters of related workloads. After parsing and cleaning the identifying metadata, or if the process 500 determined (at 510) that identifying metadata did not need to be parsed and cleaned, the process 500 performs (at 520) an identifying metadata similarity metric on the identifying metadata of the workloads. In some embodiment, the name similarity metric is a Jaccard similarity metric. In some embodiments, the Jaccard string similarity metric and/or some other similarity metric is applied to every set of workload identifying metadata in order to compare the similarity of each set of workload identifying metadata to each other set of workload identifying metadata.

Some embodiments use the following formula (e.g., comparing each workload name to the names of every other workload) to compute an identifying metadata similarity value.

$${s}_{t} = \frac{{T}_{0} ⋂ {T}_{1}}{{T}_{0} ⋃ {T}_{1}} \qquad ( eq . 3 )$$

### Where:

T₀: set of workload₀'s identifying metadata items
T₁: set of workload₁'s identifying metadata items
example:
workload₀ identifying metadata items {database, merchandise, shoes}
workload₁ identifying metadata items {database, merchandise, food}

$${s}_{t} = \frac{2}{4} = 0.5 \qquad ( eq . 4 )$$

The process 500 then generates (at 525) a similarity score for each workload based on the workload identifying metadata. In some embodiments, generating the similarity score for a particular workload may include storing the calculated similarity scores for each identifying metadata similarity calculation between the particular workload and each of the other workloads (e.g., as a vector associated with the particular workload). In other embodiments, generating the similarity score for each workload further includes some further mathematical, data aggregation, or data organizing of the identifying metadata similarity metric data performed in operation 520. After generating the similarity scores for each workload, the process 500 then ends.

Although process 400 of FIG. 4 and process 500 of FIG. 5 are shown here as separate processes, one of ordinary skill in the art will understand that in some embodiments, workload clusters may be identified based on similarities calculated from both workload names and workload identifying metadata. FIG. 6 conceptually illustrates a process 600 of some embodiments for generating a similarity score for each workload based on both the workload name and identifying metadata. The process 600 starts by receiving (at 605) the workload names and identifying metadata sets for each workload. The process 600 then parses and cleans (at 610) the identifying metadata sets. In some embodiments operation 610 is performed in a similar or identical manner to the embodiments described with respect to operations 510 and 515 of process 500 of FIG. 5.

The process 600 performs (at 615) a name similarity metric on the names of the workloads (e.g., generating a similarity value between the name of each workload and the names of every other workload). In some embodiments, this is performed as described with respect to operation 410 of FIG. 4. The process 600 performs (at 620) an identifying metadata similarity metric on the identifying metadata of the workloads (e.g., generating a similarity value between the identifying metadata of each workload and the identifying metadata of every other workload). In some embodiments, this is performed as described with respect to operation 520 of FIG. 5.

The process 600, of FIG. 6, then generates (at 625) a combined similarity score for each workload. In some embodiments, the process 600 uses the following formula to calculate a combined similarity score for each pair of workloads.

$$Compute Similarity = \{ \begin{matrix}arctanh ( {s}_{n} ) , if \vert {T}_{0} ⋃ {T}_{1} \vert = 0 \\ arctanh ( \frac{{s}_{n} + {s}_{t}}{2} ) , otherwise\end{matrix} \qquad ( eq . 5 )$$

### Where:

sₙ=workload name similarity (See, e.g., eq. 1)
sₜ=workload identifying metadata similarity (See, e.g., eq. 3)

In some embodiments, generating the similarity score for a particular workload may include storing the calculated similarity scores for each combined similarity calculation between the particular workload and each of the other workloads (e.g., as a vector associated with the particular workload). In other embodiments, generating the similarity score for each workload further includes some further mathematical, data aggregation, or data organizing of the combined similarity metric data produced in operation 625. After generating the similarity scores for each workload, the process 600 then ends.

Once the vector creation has been performed and the similarity scores have been generated, some embodiments then identify clusters of the workloads (See, e.g., operation 315 of FIG. 3). FIG. 7 conceptually illustrates a process 700 of some embodiments for identifying clusters of workloads. The process 700 creates (at 705) a matrix of workload vectors (e.g., workload vectors generated by process 400 of FIG. 4 and/or process 500 of FIG. 5). One of ordinary skill in the art will understand that, in some embodiments that create clusters based on both workload names and workload identifying metadata, the process 700 of FIG. 7 may create separate vector matrices for vectors based on names and vectors based on identifying metadata. The process 700 then reduces (at 710) the dimensionality of the vectors in the matrix. In some embodiments, reducing the dimensionality of the vectors in the matrix includes using principal component analysis (PCA). In other embodiments, other techniques are used to reduce the dimensionality of the vectors. The process 700 then identifies (at 715) clusters of workloads, based on the dimensionally reduced matric, using a clustering algorithm. In some embodiments, the clustering algorithm is an HDBSCAN algorithm.

FIG. 8 illustrates an example of a datacenter 800 in which some embodiments of the invention are implemented. As shown, the datacenter 800 includes multiple hosts 802. Each host includes one or more service engines 830, several VMs 805, and a software forwarding element (SFE) 812 (in some embodiments, the SFEs may be virtual switches, virtual routers, etc.). The VMs includes service VMs (SVMs) that perform middlebox service operations or guest VMs that perform compute operations for one or more tenants of the datacenter. The service engines 830 also perform middlebox service operations in some embodiments.

The datacenter 800 also includes one or more servers 814 that implement network managers and/or controller to manage and control the service engines 830, VMs 805, and SFEs 812. The hosts and servers communicate with each other through the network. In some embodiments, one or more of the VMs 805 or servers 814 execute the above-described application clustering and visualization processes of some embodiments of the invention. These processes perform the automated cluster analysis described above and generate the user interface through which administrators can visualize the clusters workloads (e.g., as shown in FIG. 1) and define forwarding and service rules and policies. The servers 814 communicate with the hosts 802 through the network 850 to provide these rules and policies.

In some embodiments, a workload may be any of: an application running on a VM 805, an application running directly on a host 802, a container or Pod executing on a VM 805 or on a host 802, or some other element in the network of the datacenter 800. In some embodiments, the workloads connect to logical networks, physical networks, or some workloads on physical networks and some on logical networks. The automatic clustering processes of some embodiments shows workloads of a physical network, logical network, or both. The workloads shown by the automatic clustering application of some embodiments may be implemented by machines at a single physical location or multiple physical locations.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here, is within the scope of the invention. In some embodiments, the software programs, when installed to operate on one or more electronic systems, define one or more specific machine implementations that execute and perform the operations of the software programs.

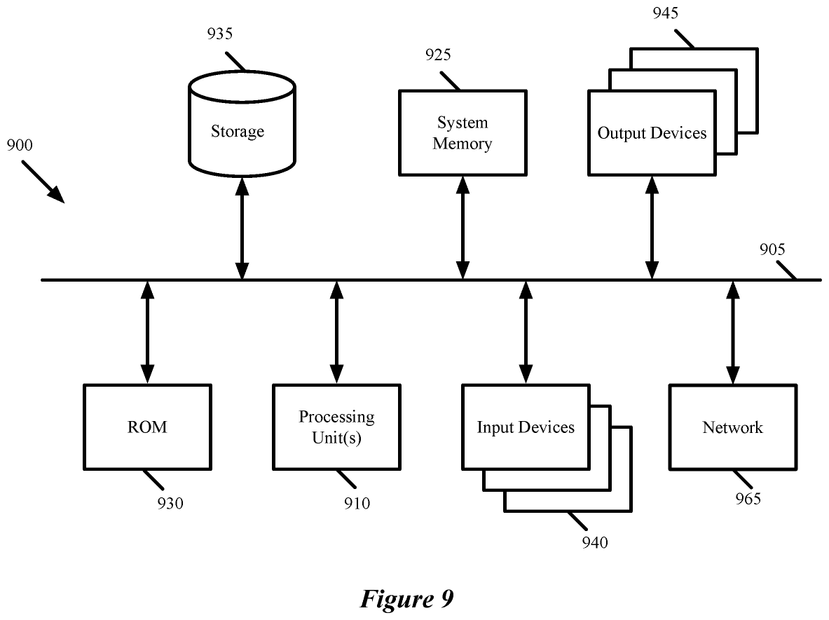

FIG. 9 conceptually illustrates a computer system 900, with some embodiments of the invention implemented. The computer system 900 can be used to implement any of the above-described hosts, controllers, gateway, and edge forwarding elements (e.g., routers). As such, it can be used to execute any of the above-described processes. This computer system 900 includes various types of non-transitory machine-readable media and interfaces for various other types of machine-readable media. Computer system 900 includes a bus 905, processing unit(s) 910, a system memory 925, a read-only memory 930, a permanent storage device 935, input devices 940, and output devices 945.

The bus 905 collectively represents all system, peripheral, and chipset buses that communicatively connect the numerous internal devices of the computer system 900. For instance, the bus 905 communicatively connects the processing unit(s) 910 with the read-only memory 930, the system memory 925, and the permanent storage device 935.

From these various memory units, the processing unit(s) 910 retrieve instructions to execute and data to process in order to execute the processes of the invention. The processing unit(s) may be a single processor or a multi-core processor in different embodiments. The read-only-memory (ROM) 930 stores static data and instructions that are needed by the processing unit(s) 910 and other modules of the computer system. The permanent storage device 935, on the other hand, is a read-and-write memory device. This device is a non-volatile memory unit that stores instructions and data even when the computer system 900 is off. Some embodiments of the invention use a mass-storage device (such as a magnetic or optical disk and its corresponding disk drive) as the permanent storage device 935.

Other embodiments use a removable storage device (such as a floppy disk, flash drive, etc.) as the permanent storage device 935. Like the permanent storage device 935, the system memory 925 is a read-and-write memory device. However, unlike storage device 935, the system memory 925 is a volatile read-and-write memory, such as random access memory. The system memory 925 stores some of the instructions and data that the processor needs at runtime. In some embodiments, the invention's processes are stored in the system memory 925, the permanent storage device 935, and/or the read-only memory 930. From these various memory units, the processing unit(s) 910 retrieve instructions to execute and data to process, in order to execute the processes of some embodiments.

The bus 905 also connects to the input and output devices 940 and 945. The input devices 940 enable the user to communicate information and select commands to the computer system 900. The input devices 940 include alphanumeric keyboards and pointing devices (also called “cursor control devices”). The output devices 945 display images generated by the computer system 900. The output devices 945 include printers and display devices, such as cathode ray tubes (CRT) or liquid crystal displays (LCD), that display images generated by the computer system. Some embodiments include devices such as touchscreens that function as both input and output devices 940 and 945.

Finally, as shown in FIG. 9, bus 905 also couples computer system 900, to a network 965, through a network adapter (not shown). In this manner, the computer 900 can be a part of a network of computers (such as a local area network (“LAN”), a wide area network (“WAN”), or an Intranet), or a network of networks (such as the Internet). Any or all components of computer system 900 may be used in conjunction with the invention.

Some embodiments include electronic components, such as microprocessors, storage, and memory, that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessors or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer-readable medium,” “computer-readable media,” and “machine-readable medium” are entirely restricted to tangible, physical objects, that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. For instance, several of the above-described embodiments deploy gateways in public cloud datacenters. However, in other embodiments, the gateways are deployed in a third-party's private cloud datacenters (e.g., datacenters that the third-party uses to deploy cloud gateways for different entities in order to deploy virtual networks for these entities). Thus, one of ordinary skill in the art would understand that the invention is not to be limited by the foregoing illustrative details, but rather is to be defined by the appended claims.

1. A method of displaying consolidated workload data for a network, the method comprising:
for each of a plurality of workloads:
receiving a set of identifiers characterizing the workload; and
converting the set of identifiers to a vector representation of the workload;
identifying clusters of workloads based on the vector representations of the workloads;
displaying the plurality of workloads grouped in the identified clusters; and
displaying data flows between the clusters of workloads.

2. The method of claim 1, wherein converting the set of identifiers to a vector representation of the workload comprises applying a similarity metric to the set of identifiers.

3. The method of claim 2, wherein the identifiers characterizing the workload comprise a compute name of the workload.

4. The method of claim 3, wherein the similarity metric is a Jaro similarity metric.

5. The method of claim 2, wherein the identifiers characterizing the workload comprise a set of identifying metadata of the workload.

6. The method of claim 5, wherein the similarity metric is a Jaccard similarity metric.

7. The method of claim 1, wherein identifying clusters of workloads based on the vector representations of the workloads comprises creating a matrix of the vector representations of the workloads in the plurality of workloads.

8. The method of claim 7, wherein identifying clusters of workloads based on the vector representations of the workloads further comprises reducing a dimensionality of the vectors in the matrix using principal component analysis (PCA).

9. The method of claim 8, wherein identifying clusters of workloads based on the vector representations of the workloads further comprises applying a clustering algorithm to the matrix.

10. The method of claim 9, wherein the clustering algorithm is a hierarchical density based spatial clustering of applications with noise (HDBSCAN) algorithm.

11. The method of claim 1, wherein the identifiers characterizing the workload comprise both a compute name of the workload and a set of identifying metadata of the workload.

12. The method of claim 1, wherein displaying data flows between the clusters of workloads comprises displaying data flows between a first workflow in a first cluster and a second workflow in a second cluster.

13. A non-transitory machine readable medium storing a program which when executed by at least one processing unit displays consolidated workload data for a network, the program comprising sets of instructions for:
for each of a plurality of workloads:
receiving a set of identifiers characterizing the workload; and
converting the set of identifiers to a vector representation of the workload;
identifying clusters of workloads based on the vector representations of the workloads;
generating display data for displaying the plurality of workloads grouped in the identified clusters; and
generating display data for displaying data flows between the clusters of workloads.

14. The non-transitory machine readable medium of claim 13, wherein the set of instructions for converting the set of identifiers to a vector representation of the workload comprises a set of instructions for applying a similarity metric to the set of identifiers.

15. The non-transitory machine readable medium of claim 14, wherein the identifiers characterizing the workload comprise a compute name of the workload.

16. The non-transitory machine readable medium of claim 15, wherein the similarity metric is a Jaro similarity metric.

17. The non-transitory machine readable medium of claim 14, wherein the identifiers characterizing the workload comprise a set of identifying metadata of the workload.

18. The non-transitory machine readable medium of claim 17, wherein the similarity metric is a Jaccard similarity metric.

19. The non-transitory machine readable medium of claim 13, wherein the set of instructions for identifying clusters of workloads based on the vector representations of the workloads comprises a set of instructions for creating a matrix of the vector representations of the workloads in the plurality of workloads.

20. The non-transitory machine readable medium of claim 19, wherein the set of instructions for identifying clusters of workloads based on the vector representations of the workloads further comprises a set of instructions for reducing a dimensionality of the vectors in the matrix using principal component analysis (PCA).
